(19) United States
(12) Patent Application Publication
(10) Pub. No.: US 2012/0303443 A1
(43) Pub. Date: Nov. 29, 2012

(54) AD IMPACT TESTING

(75) Inventors: Hatem Zeine, Redmond, WA (US); Meir Shmouely, Kirkland, WA (US); Guy Friedel, Seattle, WA (US); Christian Molnar, Maple Valley, WA (US); George A. Santino, Woodinville, WA (US)

(73) Assignee: MICROSOFT CORPORATION, Redmond, WA (US)

(21) Appl. No.: 13/117,295

(22) Filed: May 27, 2011

(51) Int. Cl. G06Q 30/00

(52) U.S. Cl. 705/14.41

(57) ABSTRACT

The impact of placing an ad on a web page may be tested before the ad is deployed on the web page. In one example, an entity submits the ad to be tested to a portal, and the ad is stored. A test manager then schedules tests of the ads on test machines. The ad may be tested by having the test machines retrieve the web page on which the ad is to be tested. If an ad is delivered with the page, that ad may be replaced with the test ad and also with a null ad that is designed to have little or no impact on the page. Performance metrics may be measured for the page with the test ad, and also for the page with the null ad. The delta between the performance metrics of the page with the test ad and the page with the null ad constitutes the impact of the ad on the page.

### BACKGROUND

Operators of web sites often monetize their sites by placing ads on their web pages. In some cases, the web site's operator places its own ads on the site. However, in many cases, web site operators allow third-party ads to be placed on their site.

Some early web ads were basic text and graphics that could be inserted into a designated region of the page. As web pages have become more sophisticated, so have ads. In many cases, ads contain code that executes in the browser. An ad may contain video or audio, as well as sequences of enhanced visuals which appear without user initiation and which furthermore may encourage the user to engage actively with the ad. An ad that is loaded with a page, therefore, may affect any part of the user experience, and may compete for resources with the page on which it is loaded.

When this competition exists between the page's main content and the ad, both the web site operator and the advertiser may suffer. The web site operator might not want a web page's main content experience to be compromised by an ad, and the advertiser may not want to pay for an ad if the content experience that the ad provides will be defeated by the page.

### SUMMARY

An ad's impact on a web page may be tested before the ad is deployed on the page. In order to test the impact of an ad, a web site operator (or a third-party service) may provide a portal though which advertisers may submit their ads for testing. The ad then may be deployed on several test machines, which load the page with the ad to be tested and measure the impact of loading the page with the ad.

When an ad is submitted for testing, it may be stored in a test data store. An ad test manager may then retrieve the ad from the test data store, and may deploy the ad on one or more test machines. Each of the test machines may be equipped with software that performs the test by loading the page on which the ad is to be tested and then deploying the ad on that page. The page on which the ad is to be tested may be obtained in the same manner as a real user would obtain the page—e.g., the test machines may be connected to the Internet, and the page may be loaded from the Internet. However, the software on each of the machines may be equipped to replace whatever ad is delivered on the page with the ad to be tested. The performance of the page and the test ad may then be measured using various performance metrics.

In order to evaluate the impact of loading the test ad with the page, the test machines may load the page once, while replacing the ad that is delivered on the page with a “null” ad—e.g., an ad that has a small amount of text and whose impact on the page may be assumed to be negligible; often this minimal amount of text can be a 1×1 pixel. The test machine may then load the page, while replacing the ad that is delivered on the page with the test ad. The performance of the page with the “null” ad and the performance of the page with the test ad may be measured. By comparing these measurements, it is possible to determine the impact of loading the test ad with the page.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example system in which an ad may be tested.

FIG. 2 is a block diagram showing an example of replacement of an ad on a page.

FIG. 3 is a flow diagram of an example process in which the impact of deploying an ad on a page may be tested.

FIG. 4 is a flow diagram of an example process of performing a test.

FIG. 5 is a block diagram of example components that may be used in connection with implementations of the subject matter described herein.

### DETAILED DESCRIPTION

Various forms of electronic media support advertising. For example, the operator of a web site may allow ads to be rendered on its web pages. In some cases, the web site operator places its own ads on the page. However, in many cases, the ads on the page are third-party ads, provided by a party other than the web site operator. Since the developers of third-party ads may be unfamiliar with the intricacies of the pages served by the web site, the developers of the ads may not know how the ad will interact with the web site's pages. Thus, developers of third-party ads may want to test how their ads will interact with a given web site before deploying an ad. Even when the ad is developed by the same entity that operates the web site, the ad developers may want to test how their ad will interact with the main content of the web site.

Modern ads can interact with web sites in a variety of ways. Early web ads were simple text and/or graphics that could be displayed in a designated region of a web page—e.g., within a rectangle of a known size on the side of a page. However, modern web pages and modern ads often contain code that is used to render complex user experiences. In many cases, the experience that is provided is not limited to a fixed area of the screen. These experiences may include audio and video, as well as other rich visual experiences which do not depend on user interaction and may yet encourage user interaction by reacting to the user's behavior (such as hovering or clicking on the ad surface). In many cases, the process of delivering this experience is computationally intensive and consumes significant resources on the user's machine. A page's main content and an ad that the page hosts may compete for the same resources. For example, the main content of the page and the ad may perform intensive computation, thereby competing for the machine's processor(s). Or, the main content and the ad may both attempt to deliver audio at the same time, or may want to render images (moving or still) at the same place on the screen. When the ad is not limited to displaying text and graphics in a fixed region, it is difficult to predict how the main content of a page and the ad will interact with each other. These are some of the reasons to test the interaction between a page and an ad before the ad is deployed on the page.

Adverse interactions between a web page and an ad may diminish value for both the web site operator and the advertiser. Many ads are carefully designed to render a particular user experience. For the advertiser, an ad that performs poorly with a page may fail to deliver the user experience that the advertiser expects to provide, thereby reducing the engagement with the ad. For the web site operator, an ad that interacts poorly with a page may reduce the quality of the experience that the web site is trying to provide, thereby damaging the web site's reputation for a quality or consistent experience. Thus, web site operators and advertisers both have incentives to test the interaction of an ad with a page before deploying the ad on the page.

The subject matter described herein may be used to test the impact of deploying an ad on a page. The test may be performed before the ad is actually deployed. For the advertiser, testing in advance of deployment allows the advertiser to optimize the behavior of the ad with the page. For the web site operator, testing before deployment allows the advertiser to learn the impact of an ad before deployment, possibly leading to modification of the page to accommodate a particular ad (or a new advertising technique that may be encountered in future ads), or possibly leading to the rejection of the ad as being incompatible with the web site.

In order to test ads, the subject matter herein provides an ad test portal. An advertiser may subscribe to the portal, thereby allowing the advertiser to submit ads for testing. When the advertiser submits an ad for testing, the ad is stored in a test store. A test manager then schedules the ad for testing on one or more test machines. Each of the test machines is connected to the Internet, and may contain software to execute a test and to measure the results. When an ad is to be tested, the test manager sends the ad to one or more of the test machines. The test machines may be configured to have different characteristics, so as to duplicate a variety of different conditions under which a page might be viewed by a user—e.g., the machines may have different memory sizes, different processing capacity, different types and/or speeds of connection to the Internet, different browsers, and/or various other differences. A test machine performs the test by requesting the page on which the ad is to be deployed in the same manner as a user would request that page—e.g., by requesting the page from the web site's server through the Internet.

To the web server, the page request that is made in the course of performing a test is indistinguishable from a page request that comes from a normal user. Therefore, the page is typically delivered to the test machine with whatever ad that is currently being placed on that page. In order to perform the test, the software on the test machine is able to detect and remove the ad, so that the ad can be replaced. As part of the testing process, the software on the test machine may first load the page and replace the ad on the page with a “null” ad. A “null” ad is one that contains very little content, such as simple text or even just a single 1×1pixel. Such an ad is unlikely to interfere significantly with the main content on the page. The page's performance with the null ad is measured. Then, the page is loaded again, and the ad on the page is replaced with the ad to be tested. The page's performance with the test ad is also measured. By comparing the page's performance on the test ad with the page's performance on the null ad, it is possible to determine the impact of the test ad on the page. This impact is normally the delta between between the page with the test ad and the page with the null ad.

To encourage accurate results, each machine may perform the test multiple times and under a variety of conditions. For example, each machine may repeat the test a number of times (e.g., ten times), with delays between the tests, in order to reduce the chance that a particular performance measurement is due to anomalous network conditions that are beyond the test machine's control. (E.g., a particular instance of the test might be affected by high network traffic at the moment the test is performed; repeating the test several times reduces the chance that temporary conditions such as high traffic will affect the overall results of the test). Moreover, the test machine may perform both a “cold” load of the page (with a clear cache), and a “refresh” (where elements that have previously been loaded are retrieved from the cache if they are available), since a page/ad combination may perform differently on a cold load than on a refresh load. The test machine may also load the test ad without the page on which the ad is to be placed, in order to collect performance data on the ad without the page. It is noted that the following describes “an ad” being tested on a page, although a system could also test multiple ads on a page using the techniques described herein.

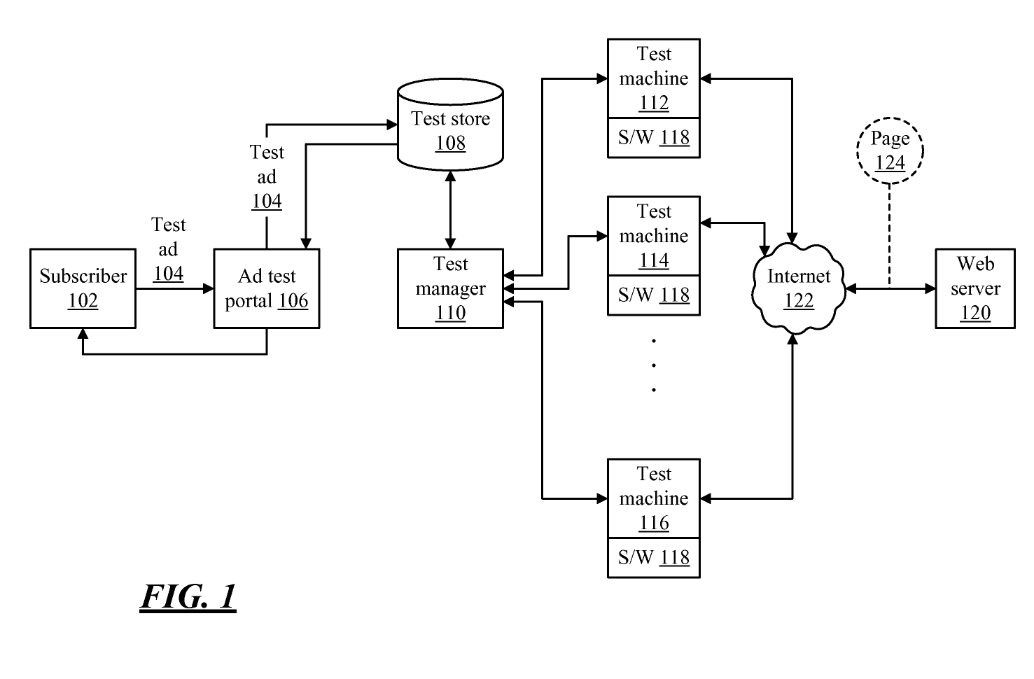

Turning now to the drawings, FIG. 1 shows an example system in which an ad may be tested. Subscriber 102 is an entity that may want to test the interaction of an ad with a web page. The entity that wants to test the ad is referred to as a “subscriber” in the sense that an ad testing service may limit the use of its service to subscribers who have registered for the service. However, a testing service could perform tests for unregistered entities, and the subject matter herein is not limited to systems in which the entities that submit ads for tests have registered for subscriptions.

Subscriber 102 creates test ad 104, and submits the test ad to ad test portal 106. Ad test portal 106 may be a web server that subscriber 102 can visit with a browser, but could take any appropriate form. Ad test portal 106 may provide an interface through which the subscriber submits test ad 104—e.g., by providing code that allows subscriber 102 to upload files containing test ad 104. When subscriber 102 has provided test ad 104 to ad test portal 106, test ad 104 may be stored in test store 108. Test store 108 may be a database or any other storage facility in which test ad 104 may be stored, so that the test ad later can be deployed to the various test machines.

Test manager 110 is a component that deploys test ad 104 for testing on various test machines. Test manager 110 may, for example, be a software component that runs on a computer, although test manager 110 could take any appropriate form. Test manager 110 schedules testing of test ad 104 on one or more test machines, and causes the scheduled tests to take place on the test machines. In the example of FIG. 1, three test machines 112, 114, and 116 are shown, although a system in accordance with the subject matter herein could have any number of test machines (as indicated in FIG. 1 by the vertical ellipsis between test machines 114 and 116).

Each of test machines 112-116 is equipped with a copy or version of software 118, which assists test machines 112-116 in performing the test. In particular, software 118 receives instructions from test manager 110 to perform a test, and is able to replace the ad that appears on a web page with another ad. In particular, this capability to replace ads may be used by software 118 to replace the ads on web pages with test ad 104, and also with the “null” ad mentioned above. Software 118 may also be capable of measuring the performance of a page that is being tested. Examples of performance measurements include: time for a page to load, time for execution of scripts on the page to complete, the extent to which an ad overtakes the visual “real estate” of the page, or any other type of information that could be relevant to measuring how an ad performs on a page. Additionally, software 118 may be capable of throttling the network bandwidth of the test machine on which it runs, in order to simulate the loading of a page with its ad under a variety of network conditions.

When test manager 110 has instructed the software 118 on a particular machine to perform a test, software 118 may carry out the instruction as follows. Software 118 may open a browser and request, from web server 120, the page on which the ad is to be tested. Web server 120 may be a machine (or cluster of machines) that serves pages for a particular web site via the Internet 122. It is noted that the system of FIG. 1 may be offered by the operator of a web site in order to allow third-party advertisers to test their ads on that web site, in which case the operator of the system of FIG. 1 may have the technical ability to provide pages from the web site to its test machines without having to deliver those pages to the test machines through the Internet. (E.g., if the entity that operates the test machines is the same entity that operates the web site, then it might theoretically be possible for the test machines to access the web site through an intranet.) However, in order to simulate, as accurately as possible, the conditions under which an ordinary user would request a page, test machines 112-116 may obtain the page on which the ad is to be tested through the Internet.

When a page is requested from web server 120, web server 120 responds by providing the page 124 through the Internet. Since the test machine requests the page from web server 120 in the same manner as an ordinary user would do so, web server 120 provides the page with whatever ad has been placed on the page—just as web server 120 would do when servicing an ordinary user request. Thus, software 118 on the test machine removes the ad from the page, so that the test machine can replace the ad with a different ad. In one example, the test machine tests the page with both the null ad and with the test ad. As noted above, the null ad provides little or no interaction with the main content of the page, so collecting performance data both for the page with the null ad, and for the page with the test ad, allows the ad's impact on the page to be quantified. Moreover, in one example the test machine loads the page in two different ways: once as a “cold” load (with a clear cache), and once as a “refresh” (using items from the cache if those items are available). Thus, a test cycle performed by a test machine may involve four loads of the page: (1) the page with the null ad, loaded “cold”; (2) the page with the null ad loaded as a “refresh”; (3) the page with the test ad, loaded cold; and (4) the page with the test ad, loaded as a refresh. Additionally, since conditions on the test machine, and condition in the Internet, may change over time, this cycle may be repeated several times and the performance data may be averaged over several cycles, in order to make it less likely that the test results are being affected by anomalous conditions at the test machine or on the network.

As noted above, the various test machines may differ from each other in some respect. For example, the machines may have different amounts of memory, different processing capacity, different forms of network connectivity (e.g., WiFi, mobile broadband, wired connections at various different bandwidths, etc.), or different amounts of other software running on the machine along with the tests (in order to simulate a heavily-loaded machine). This variation among the test machines allows the test ad to be tested under a variety of conditions, thereby providing a rich set of data concerning the impact of deploying the test ad on a page.

The data that is collected by running tests describes the performance of the page with the test ad, and also described the performance of the page with the “null” ad. By comparing performance under these two conditions, it is possible to quantify the impact of combining the ad with the page. Data collected by the test machines may be collected in the test store (as indicated by the arrows leading back from the machines, to the test manager, to the test store, to the test portal). This impact may be reported to subscriber 102 (as indicated by the arrow leading from the test portal to the subscriber) and/or to the operator of the web site that web server 120 hosts. Action then may be taken, such as deploying the test ad (if the test indicates the impact is acceptable), modifying the ad to reduce the impact, or allowing the web site operator to reject the ad if the ad does not meet some performance standard.

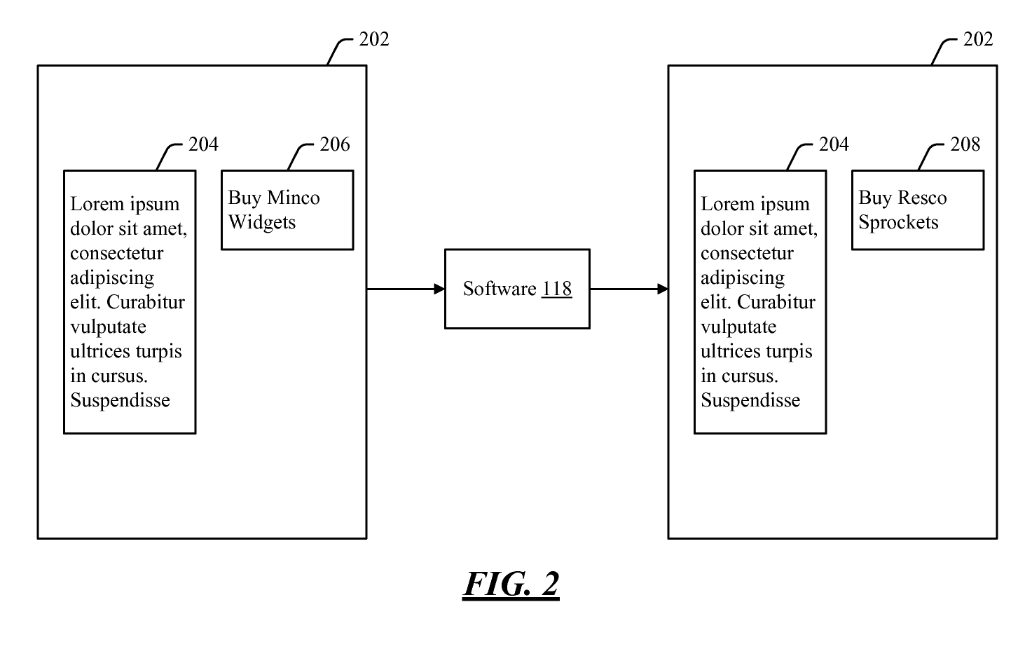

As noted above, the software 118 that is described in connection with FIG. 1 is able to replace the ad that is delivered on a page with another ad, such as a null ad or the test ad. FIG. 2 shows an example of how the ad may be replaced.

In the example of FIG. 2, web page 202 is a page that is served by a web server (such as web server 120 of FIG. 1). Web page 202 may contain content 204. Moreover, web page 202 may contain an ad 206. In the example of FIG. 2, ad 206 is an ad that has been place on web page 202, possibly by a third-party advertiser. In the example of FIG. 2, ad 206 is shown as a simple text ad that is constricted to a rectangular box on the side of the page. However, such an ad is shown in the figure merely for illustration purposes, and it will be understood that ad 206 could be any type of ad—e.g., a video ad, an audio ad, a script to be executed by a browser, or any combination of these types of content (or any other appropriate type of content). Ad 206 may be an ad that a third party has paid for—e.g., a third party may have bid some amount of money per click in order to have the ad placed on page 202 when some set of conditions is present (e.g., when the user enters certain keywords, or when the page is requested by a user who is known to have shown interest in a certain kind of product).

Software 118 is able to remove ad 206 and to replace ad 206 with a different ad 208. As noted above, the replacement ad 208 might be a null ad or a test ad (although software 118 may be capable of replacing ad 206 with any ad). Thus, as a result of software 118's performing this replacement, web page 202 may be transformed from its appearance on the left side of FIG. 2 to its appearance on the right side of FIG. 2. In this example, page 202 appears the same on both sides of FIG. 2, except that on the left side page 202 displays ad 206, while on the right side page 202 displays replacement ad 208. (It will be understood that many ads are not limited to a specific spatial region of a page, in which case the difference in the page's appearance before and after replacement might be less subtle than is shown in FIG. 2. In FIG. 2, the use of ads that are limited to small rectangles on the side of page 202 is for illustration only, and it will be understood that software 118 can remove and replace ads on a page, regardless of the form that the ads take.)

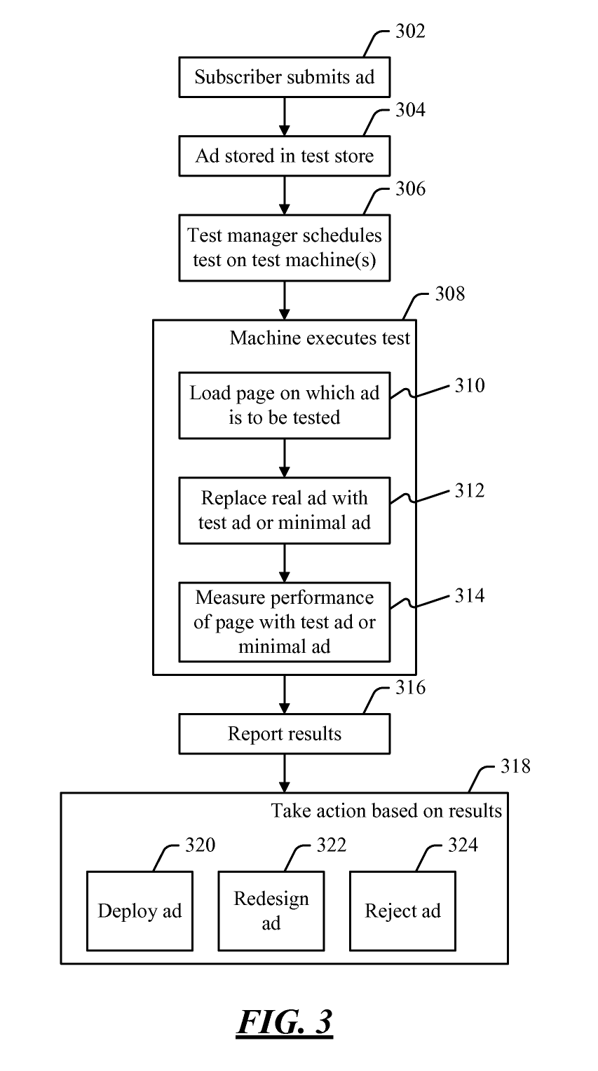

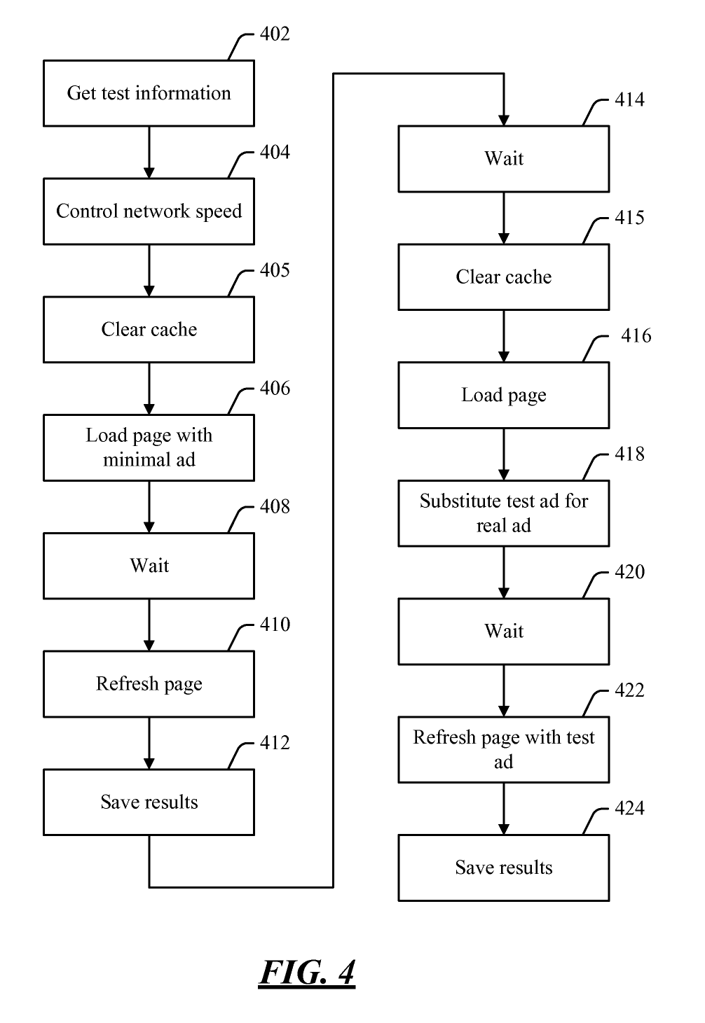

FIG. 3 shows an example process in which the impact of deploying an ad on a page may be tested. Before turning to a description of FIG. 3, it is noted that the flow diagrams contained herein (both in FIG. 3 and in FIG. 4) are described, by way of example, with reference to components shown in FIGS. 1 and 2, although these processes may be carried out in any system and are not limited to the scenarios shown in FIGS. 1 and 2. Additionally, each of the flow diagrams in FIGS. 3 and 4 shows an example in which stages of a process are carried out in a particular order, as indicated by the lines connecting the blocks, but the various stages shown in these diagrams can be performed in any order, or in any combination or sub-combination.

At 302, an entity may submit a test ad whose impact is to be tested on a web page. For example, with reference to the components in FIG. 1, subscriber 102 may submit test ad 104. At 304, the test ad may be stored in a test store.

At some point after the test ad is stored, a test of the ad may be scheduled on one or more test machines (at 306). The scheduling of the test may be performed by a component such as test manager 110 (shown in FIG. 1). At 308, the test machines may execute the tests.

Execution of the tests at 308 may be performed using the following example actions. At 310, the page on which the ad is to be tested may be loaded. The page may be loaded by requesting the page through the Internet from the web server that serves the page. Since the web server serves the page to the test machine in effectively the same manner as it would serve the page to an ordinary user, the page may be served with whatever ad has been placed on the page. For example, the web page may include code to retrieve and include an ad that is chosen and provided by a web advertisement service. Since the ad that is included is not likely to be the ad that has been submitted for testing, the test machine may remove the ad from the page (at 312) and may replace the ad with the test ad and/or with a null ad. The mechanisms that may be used to remove the ad are described above in connection with FIGS. 1 and 2. When the ad has been replaced with the test ad or with the null ad, performance of the page may be measured using various metrics (at 314).

Some examples of the metrics that may be measured at 314 include the following:

The number of scripts (e.g., JavaScripts), images (e.g., JPEG files), or other items of content that appear on the page;

The speed at which scripts execute and complete;

The resolution of images that appear on the page;

A map of whether files on the page load sequentially or in parallel;

The amount of memory used in loading and rendering the page;

The percentage of processor capacity that is used in loading and rendering the page;

The length (in time) of any animations that appear on the page;

The total number of bytes on the page;

The total number of files that are retrieved in the course of loading the page.

The cacheability of all files/assets on the page.

It will be understood that, in the above bullet list, “the page” refers to the page with any ad (null ad, test ad, or otherwise) that has been placed on the page during the test. For example, if the test machine has replaced the ad delivered on the page with the ad that is to be tested, then a metric that measures “the total number of bytes on the page” may actually measure the number of bytes in the main content of the page, plus the number of bytes that are in any ad placed on the page. Similarly, a metric that measures the length of animations that appear on the page may actually measure the length of animations that appear in the main content of the page as well as those animations that appear in any ad placed on the page.

Once the test has been performed and metrics have been calculated, results may be reported (at 316). In one example, the results include a comparison of the metrics measured for the page with the null ad and the metrics measured for the page with the test ad, thereby allowing quantification of the impact of placing the test ad on the page. Moreover, in one example, the results include comparisons both for “cold” loads of the page and “refresh” loads of the page—e.g., the results may include a comparison of a cold load of the page with the test ad and a cold load of the page with the null ad, and may also include a comparison of a refresh load of the page with the test ad and a refresh load of the page with the null ad.

When results have been reported, action may be taken based on the results (at 318). Some examples of the actions that may be taken are shown in FIG. 3. One example action is to deploy the ad (at 320). For example, if the results reported at 318 show that the ad performed acceptably on a page, then the entity that submitted the ad for testing may decide to deploy the ad in its current form. Another example action is to redesign and/or modify the ad (at 322). For example, if the results indicate that the ad did not perform acceptably (e.g., if the ad increased the page load time by several seconds, or used the memory and/or processor at a very high level, then the entity that submitted the ad for testing may decide to redesign the ad in order to reduce the ad's impact on the page. Another example action is to reject the ad (at 324). This example action may be performed, for example, by the operator of the web site on which the ad is being tested. Some web site operators might not want to place ads on their page if the ad's impact on the page exceeds a certain level. Thus, even if the entity that created the ad is willing to deploy the ad on the page, the web site operator might reject the ad. It is noted that, in some cases, the interests of the advertiser and the web site operator may be in conflict: e.g., the advertiser might want an advertisement to take over the user experience provided by the page, while the web site operator might want the ad to be relatively unobtrusive in order to ensure that the user experience provided by the page is what the web site operator intended.

Block 308 of FIG. 3 contains a basic outline of performing a test. FIG. 4 shows an example process, in greater detail, and example process that a test machine may carry out in order to perform a test. At 402, the machine may get test information. The test information may, for example, include an ad to be tested, and an instruction to perform the test. The test ad and instruction may come, for example, from test manager 110 (shown in FIG. 1). At 404, the test machine may throttle, or otherwise control, the network speed in some manner. For example, the network connection on the test machine might have a high bandwidth, but the test might call for the ad to be tested at a lower bandwidth than is available to the machine, in which case the machine might restrict its network throughput to match the lower bandwidth called for by the test. In one example, the instruction received from the test manager indicates the network speed at which the ad is to be tested, although the machine might be preconfigured to test at a particular bandwidth and thus might control the network speed without an explicit instruction from the test manager.

At 406, the page may be loaded with a null ad. The load that occurs at 406 is a “cold” load—i.e., a load that does not draw on the cache. (The cache may be cleared at 405 prior to the load.) At 408, the test machine waits for some amount of time, and then, at 410, refreshes the page (including the null ad). The refreshed page is able to draw information from the cache (if the relevant information is available in the cache), but can also retrieve some or all of the page over the Internet from the web server that serves the page. The wait that occurs at 408 is designed to allow the machine to “clear out” whatever processes the machine is performing after loading the page. For example, the operating system on the machine may be performing various page swapping and/or memory garbage collection tasks after a page load—particularly if the page is computationally intensive to render. Additionally, the wait allows open ports to be closed, allows file downloads to complete, and allows any measurement tools to load. Allowing these processes to finish before refreshing the page reduces the chance that the performance measurements taken for the refreshed page will be affected by processes that are unrelated to the page itself. When the page is loaded “cold”, and when the page is refreshed, performance metrics were captured, and the result of capturing these metrics may be saved at 412.

Following another wait (at 414), the page is loaded again (at 416), but this time the page is loaded, the test ad is substituted for the ad that was delivered with the page (at 418). The load of the page and the ad that occurs at 416 is a “cold” load (i.e., not drawing on the cache—the cache may be cleared at 415 prior to the page load). Performance metrics concerning the load of the page with the test ad may be captured. Following another wait (at 420), the page with the test ad may be refreshed (at 422), thereby allowing the load of the page to draw on the cache. Performance metrics may also be captured for the refresh load of the page and the ad. At 424, the performance metrics for both the cold and refreshed load of the page with the test ad may be saved. The various metrics that are stored may then be compared and reported in the manner previously described in connection with FIGS. 1-3.

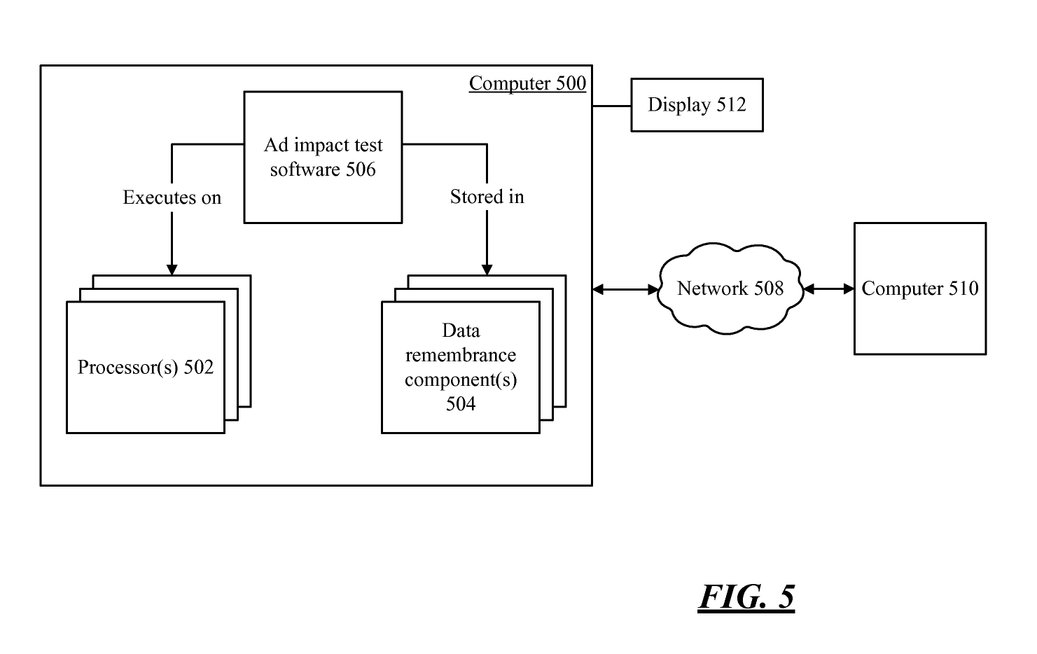

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is ad impact test software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable storage media. Tangible media, such as an optical disks or magnetic disks, are examples of storage media. The instructions may exist on non-transitory media. The instructions may also be stored on one or more computer readable storage devices, where each device may comprise a hardware component such as a semiconductor memory, optical disk, or other type of component that durably stores information. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium. It is noted that there is a distinction between media on which signals are “stored” (which may be referred to as “storage media”), and—in contradistinction—media that transmit propagating signals. DVDs, flash memory, magnetic disks, etc., are examples of storage media. On the other hand, wires or fibers on which signals exist ephemerally are examples of transitory signal media.

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

It is noted that the claims may describe various items as being “distinct.” To say that two items are distinct is to say that they are not the same instance of the item. For example, in the context of this application, there may be two ads: a test ad and a null ad. It may be said that the test ad is distinct from the null ad, in the sense that the test ad and the null ad are not the same ad.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage devices that store executable instructions to test an impact of a first ad, wherein the executable instructions, when executed by a computer, cause the computer to perform acts comprising:
receiving said first ad from an entity;
storing said first ad in a test store;
scheduling a test of said first ad on a first one of a plurality of test machines;
at said first one of said test machines, retrieving a page on which said first ad is to be tested, said page being retrieved with a second ad that is distinct from said first ad;
replacing said second ad with said first ad;
measuring a first set of performance metrics of said page with said first ad; and
providing results based on said first set of performance metrics.

2. The one or more computer-readable storage devices of claim 1, wherein said acts further comprise:
replacing said second ad with a null ad;
measuring a second set of performance metrics of said page with said null ad;
wherein said providing of said results is based on a comparison of said first set of performance metrics with said second set of performance metrics.

3. The one or more computer-readable storage devices of claim 1, wherein said acts further comprise:
clearing a cache;
after said clearing of said cache, loading said page with said first ad, said first set of performance metrics being measured based on said loading of said page with said cache being clear;
after loading of said page with said cache being clear, refreshing said page with said first ad while using one or more elements of said page or said first ad from said cache; and
measuring a second set of performance metrics based on refreshing of said page.

4. The one or more computer-readable storage devices of claim 1, wherein said acts further comprise:
limiting a speed of a network connection at said first one of said test machines prior to retrieving said page.

5. The one or more computer-readable storage devices of claim 1, wherein said plurality of test machines have different characteristics from each other, and wherein said acts further comprise:
scheduling said test of said first ad on a second one of said plurality of test machines, said first one of said plurality of test machines and said second one of said plurality of test machines having at least one characteristic different from each other.

6. The one or more computer-readable storage devices of claim 5, wherein said at least one characteristic comprises that differs between said first one of said plurality of test machines and said second one of said plurality of test machines comprises a level of processing capacity.

7. The one or more computer-readable storage devices of claim 5, wherein said at least one characteristic comprises that differs between said first one of said plurality of test machines and said second one of said plurality of test machines comprises a type of network connection.

8. The one or more computer-readable storage devices of claim 5, wherein said at least one characteristic comprises that differs between said first one of said plurality of test machines and said second one of said plurality of test machines comprises an amount of memory.

9. A system for testing an impact of a first ad, the system comprising:
a memory;
a processor;
a test store;
a plurality of test machines, each of said test machines being connected to a network and having software that replaces an ad on a page;
a portal that receives said first ad from an entity and stores said first ad in said test store; and
a test manager that schedules a test of said first ad on a first one of said plurality of test machines and causes said first one of said test machines to retrieve said page on which said first ad is to be tested, said page being retrieved with a second ad that is distinct from said first ad, said test manager further causing said first one of said test machines to replace said second ad with said first ad, said test manager causing said first one of said test machines to measure a first set of performance metrics of said page with said first ad.

10. The system of claim 9, wherein said first one of said test machines replaces said second ad with a null ad and measures a second set of performance metrics of said page with said null ad;
wherein said system provides results based on a comparison of said first set of performance metrics with said second set of performance metrics.

11. The system of claim 9, wherein said first one of said test machines comprises a cache, wherein said first one of said test machines clears said cache, then loads said page with said first ad with a clear cache, and then refreshes said page with said first ad while using one or more elements of said page or said first ad from said cache.

12. The system of claim 9, wherein said first one of said test machines limits a speed of said first one of said test machine's network connection prior to retrieving said page.

13. The system of claim 9, wherein said plurality of test machines have different characteristics from each other, and wherein said test manager schedules said test of said first ad on a second one of said plurality of test machines, said first one of said plurality of test machines and said second one of said plurality of test machines having at least one characteristic different from each other.

14. The system of claim 9, wherein said first one of said plurality of test machines performs said test a plurality of times and collects performance metrics for each time said test is performed.

15. A method of testing an impact of a first ad, the method comprising:
using a processor to perform acts comprising:
receiving said first ad from an entity;
storing said first ad in a test store;
scheduling a test of said first ad on a first one of a plurality of test machines;
at said first one of said test machines, retrieving a page on which said first ad is to be tested, said page being retrieved with a second ad that is distinct from said first ad;
replacing said second ad with a null ad;
measuring a first set of performance metrics of said page with said null ad;
retrieving said page and replacing said second ad with said first ad;
measuring a second set of performance metrics of said page with said first ad; and
providing results on said impact based on a comparison of said first set of performance metrics with said second set of performance metrics.

16. The method of claim 15, wherein said acts further comprise:
limiting a speed of a network connection at said first one of said test machines prior to retrieving said page.

17. The method of claim 15, wherein said acts further comprise:
clearing a cache at said first one of said test machines;
after said clearing of said cache, loading said page with said null ad, said first set of performance metrics being measured based on said loading of said page with said cache being clear;
after loading of said page with said cache being clear, refreshing said page with said null ad while using one or more elements of said page or said first ad from said cache; and
measuring a third set of performance metrics based on refreshing of said page.

18. The method of claim 17, wherein said acts further comprise:
after measuring said third set of performance metrics, performing a second clearing of said cache;
after said second clearing of said cache, loading said page with said first ad, said second set of performance metrics being measured based on loading of said page with said first ad and with said cache being clear;
after loading of said page and said first ad with said cache being clear, refreshing said page with said first ad while using one or more elements of said page or said first ad from said cache;
measuring a fourth set of performance metrics based on refreshing of said page; and
providing results on said impact based on a comparison of said third set of performance metrics with said fourth set of performance metrics.

19. The method of claim 15, wherein said plurality of test machines have different characteristics from each other, and wherein said acts further comprise:
scheduling said test of said first ad on a second one of said plurality of test machines, said first one of said plurality of test machines and said second one of said plurality of test machines having at least one characteristic different from each other.

20. The method of claim 15, wherein said acts further comprise:
based on said impact, rejecting said first ad from being used on said page.
